(19) United States
(12) Patent Application Publication
(10) Pub. No.: US 2003/0073402 A1
(43) Pub. Date: Apr. 17, 2003

(54) Listener or viewer response data logging and reporting system

(76) Inventors: Russell M. Herring, San Antonio, TX (US); Michael Glen Gould, Frisco, TX (US); James Nickolas D'Arcy, Garland, TX (US); Mark G. Polito, Dallas, TX (US)

Correspondence Address: Alan R. Thiele, JENKENS & GILCHRIST, P.C., 1445 Ross Avenue, Suite 3200, Dallas, TX, 75202-2799, US

(21) Appl. No.: 10/253,116

(22) Filed: Sep. 24, 2002

Related U.S. Application Data
(60) Provisional application No. 60/324,320, filed on Sep. 24, 2001.

(51) Int. Cl. H04H 9/00

(52) U.S. Cl. 455/2.01; 455/414

(57) ABSTRACT

A system for listener event data logging and reporting includes recording at least information describing a station being listened to and providing the information to a data collection center. Additional listener event information may include volume setting, time, and location. Collected information would be used with listener demographic information to provide reports for assisting in the management of radio programming and the effective use of commercial time.

This application claims the benefit of U.S. Provisional Patent Application No. 60/324,320 filed Sep. 24, 2001.

### FIELD OF THE INVENTION

The present invention pertains to the concept of monitoring and recording usage information from any electrical device which produces video images for viewing, sound for listening, or both, and then reporting that information wirelessly or through other means to an integrated or separate information collection point for compilation and analysis. The collected information is used for a variety of purposes to include determining advertising rates or to measure listener or viewer response.

### BACKGROUND

Currently the methods utilized by both the broadcasting and advertising industries for learning about the listener or viewer audience reached by broadcast stations are dependent on voluntary feedback from listeners or viewers using either polling techniques or questionnaires. Both polling and the use of questionnaires rely on the listener or viewer properly following a strict regimen of accurately logging the broadcast stations tuned into and the times that the listening occurred. Because most listeners or viewers are generally unaware of accurate station identification information, polling and questionnaires generally provide inaccurate results. In addition, there is an inherent delay in obtaining usable information from polling or questionnaires. Days or even weeks may pass before information is obtained, verified, analyzed, and acted upon.

It has also been found that some listeners or viewers may keep the station selector dial set on a specific station for hours but then will reduce the volume level in reaction to undesirable programming or irritating commercial messages. The listener or viewer will then return the volume to a comfortable level when the undesirable programming or irritating commercial messages are over. Commercial messages are often muted when their continued repetition makes them particularly bothersome to the listener or viewer. On the other hand, the volume level may be increased by the listener or viewer for a particularly enjoyable programming segment or an amusing commercial message.

Despite the value of listener or viewer response data to programming or commercial messages, listener or viewer response data is usually not captured. The result of not capturing listener or viewer response data is a delayed or even a false impression of listener or viewer response to programming and commercial messages. Yet information describing the response of listeners or viewers to programming and commercial messages is just what broadcast stations need to tailor their programming and advertisers need to determine which commercial messages are being well received, and which commercial messages are ineffective.

### SUMMARY

The disclosed invention is described in terms of a system that internally records listener response data for automobile radios (to include other wheeled vehicles such as motorcycles, trucks, tractors, and farm equipment) such as the station setting, the volume setting, the time, and the duration of each listening event for radios. The disclosed invention may also be adapted for use with other electrical devices which receive and produce video images. The disclosed invention may also be used with electrical devices not adapted for receiving broadcast signals. Specifically, response data may also be recorded for other non-broadcast playback devices such as DVD or VHS players, audio tape or CD players.

Listener or viewer response data indicating listener or viewer response to programming, commercial messages, or even specific songs or music tracks, is sent by wireless means or by other means to a remote or integrated data collection center (DCC). At the data collection center, listener or viewer response data and patterns therein are compared with other listener or viewer response data; for example, responses to other broadcast programs, other commercial messages, or other music tracks. The purpose of the listener or viewer response data analysis and comparison is to establish which stations, programs, music, songs, and commercial messages are being played on broadcast receivers or other devices and at what times. The listener or viewer response data and patterns may be compiled together with the characteristics of the operator of a vehicle and/or a listener or viewer and then stored at the DCC to form the basis of a ratings method. Broadcast stations and advertisers can use listener or viewer response data to learn which programs, commercial messages, and/or music tracks are being listened to or watched by a predetermined profile of listeners or viewers at predetermined times. Listener or viewer response data presents an actual empirical result of the preferences of listeners or viewers to those who make decisions based on these preferences.

An additional feature that could be added to the disclosed invention would be the location of the vehicle for each listening or viewing event. This data could be used to determine the coverage area of a broadcast station. This location data could be determined from a variety of means, including but not limited to the use of the GPS satellites.

### BRIEF DESCRIPTION OF THE DRAWING FIGURES

A still better understanding of the listener or viewer response data logging and reporting system of the present invention may be obtained from the drawing figure, wherein:

FIG. 1 is a schematic diagram of the present invention.

### DESCRIPTION OF THE EMBODIMENTS

As previously indicated, the listener or viewer response data logging and reporting system 10 of the present invention will be described in terms of its use with an automobile radio. Those of ordinary skill in the art will understand that the system of the present invention may also be used with a variety of other non-broadcast devices including at least video tape, audio tape, DVD, or CD players.

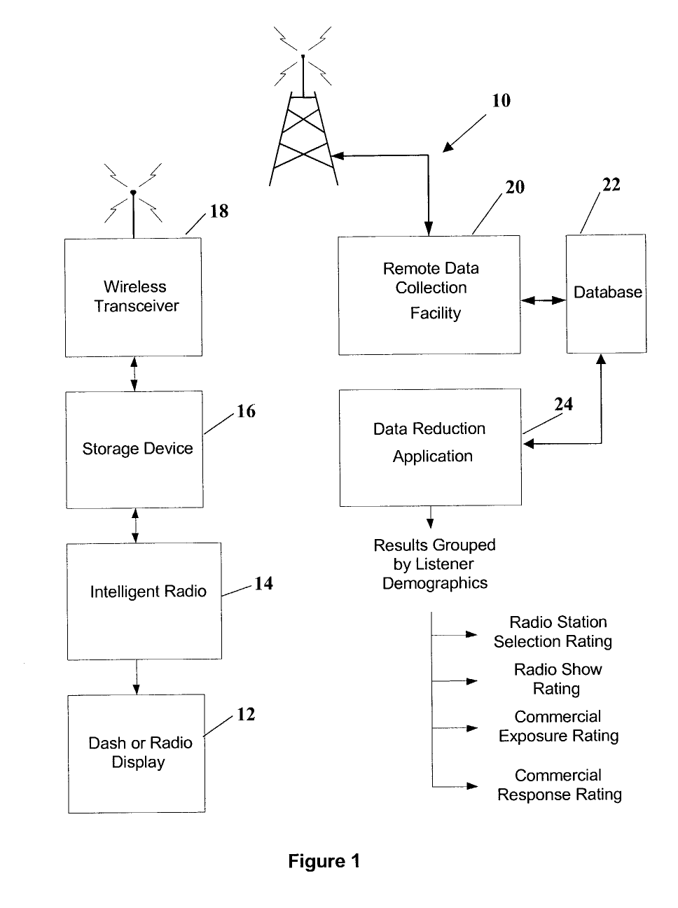

As shown in FIG. 1, the first part of the disclosed system is the automobile radio itself. The automobile radio is adjusted by the listener to tune to a desired station. An in-car display 12 identifies the radio station for the listener. The volume level is usually controlled in part by the automobile radio, but in many car radios this is not always true. The intelligent automobile radio 14 portion of the present invention converts the station selection and volume level into usable data.

A second part of the system is the listener response data storage device 16. In this section, data describing the various monitored parameters received from the intelligent automobile radio 14 is stored. Such parameters may include at least an identification of the radio station being listened to. Other parameters may include the volume setting, the time of day, and the duration of the listening event. A listening event is defined as any change in the radio controls by the radio listener. Examples of changes in radio controls would be a change in the radio station, a change in the volume setting, turning the radio on or off, or turning the radio on or off by turning the car on or off. Data describing each listening event would be stored in memory in the storage device 16. This data storage device 16 may be either part of the automobile radio itself or a separate data storage unit connected to the automobile radio located in another part of the vehicle.

The data storage device 16 compiles listener response data until the data is sent to the DCC 20. Such sending of listener response data may be either at a predetermined time or when a predetermined volume of listener response data has been stored in the data storage device 16. Once a connection, wireless 18 or by other means, is established to the DCC 20, the listener response data is transferred. The DCC is able to blend the listener response data with customer profile and historical usage data to create a large database 22 of available information. A data reduction application 24 retrieves the listener response data from the database 22 and manipulates the listener response data to produce reports based on customer demographics which are meaningful to either radio stations or advertisers.

Before listener response data logging operations are initiated, it is particularly helpful to create a user or listener profile. This profile information will then be used for the data reduction or data “mining” operation.

Radio stations typically classify themselves as featuring a musical format such as country and western, rock, classical, oldies, jazz, and gospel, or a talk format such as news, commentary, sports, call-in, and religious. Advertisers tailor their commercial messages to the listeners of either music or talk format stations in different ways depending on the characteristics of the listeners. Characteristics of listeners such as age and musical preferences are very important in determining whether or not a commercial message is effective in increasing the awareness of a product or service. For example, a livestock feed store might advertise on a country and western radio station but not on a radio station that plays primarily contemporary rock music. To assure best use of advertising money, the advertiser would like to know what radio station and at what times a listener who listed country and western as a music preference listened to a particular station. Other listener preferences such as hobbies and leisure hours could be helpful in determining commercial message effectiveness. In addition, identification of “prime times” from actual empirical data would be valuable to advertisers and radio stations for determining advertising rates charged for commercial message time to be charged at various times of the day.

As an alternative to the remote data collection facility 20, a removable data storage device could be connected either temporarily or continuously to the data storage device 16 mounted to the vehicle. The purpose of this removable data storage device 16 would be to receive listener response data from the storage device 16 mounted to the vehicle instead of transmitting the stored listener response data using a wireless connection to a remote site. This removable listener response data storage device could be easily attached and removed for listener response data examination. Examples of removable listener response data storage devices include a removable cartridge or simply a data transfer port for connection to a computer or simple memory device for downloading the stored listener response data from the vehicle.

In one embodiment, the vehicle's trunk could be opened to reveal a connection to the stored listener response data. This listener response data connection could be a wired or wireless connection. A laptop computer or similar device would then be used to establish a connection with the data storage device 16 mounted to the vehicle and, on command, the listener response data is transferred or downloaded from the vehicle. The trunk is closed and the device containing listener response data is taken away for examination and analysis. This alternate connection will be referred to as an “integrated” listener response data collection center or point.

The intelligent radio device generates the listener response data that will be logged, stored, and eventually analyzed. The intelligent radio device 14 determines and reports listening events. A listening event is created whenever the operator changes a setting on the automobile radio or turns the vehicle on/off. For example, a driver on the way to work starts his car in the morning. If the radio in the vehicle is off, then no listening events are logged. However, many drivers frequently leave their radio on when they turn off their car at the end of the day, so starting the vehicle will turn the radio on. Therefore, when the car is started, a listening event is generated with the following characteristics if the driver is listening to a radio station:

Ignition on

Radio on station X

Radio volume X

Time

Location

Three minutes later, the listener switches to another favorite station because the music that was playing or the commercial being aired was not pleasing to the driver, or another station provides needed information about congestion on major roadways. A new listening event is logged with the same list of information. After 7 minutes, a song or commercial message comes on the radio that is particularly irritating, or another station features a news commentator that the driver enjoys listening to, so the driver turns the volume down to almost nothing or changes stations. Another listening event is stored reflecting volume adjustment. After another minute, the listener turns the volume up again to about the same level it was before, but the listener notices that a favorite oldie is being played. The volume is turned way up for a sing-along. Listener response data about another listening event is stored. After the favorite song is over, the listener adjusts the volume back down. Listener response data about yet another listening event is stored. At 9:00 a.m., the listener's favorite talk show comes on another station, and the radio stations are changed. Listener response data about still yet another listening event is stored. However, during the commercial breaks on the talk show, the listener switches back to a favorite music station. For each of the changes, listener response data describing a listening event is stored. Since the listener is simply driving to work, the car is turned off about 45 minutes after it is started. Listener response data about yet another listening event is created and stored.

An enhancement of the disclosed listening event logging and reporting system is the capability to determine the geographical location of the vehicle. Data produced by a location system such as GPS mounted to the vehicle or included as part of an emergency response system could be used to provide location information as well as time data. The location data, when combined with the listener response data, would provide an empirical view of the coverage area of the geographical radio station. It is well known that radio listeners frequently change radio stations when the quality of the signal causes audio quality to degrade. At this point, listeners will generally change radio stations. Accurate time data is necessary to correlate the logged data with programming schedules. This correlation of listener response data, location data, user data, and time allows the data reduction applications to provide accurate reports on which radio programs and commercials were listened to by which listeners, at which times, and at which locations.

A still further enhancement of the system disclosed herein may include associating listening or viewing event data with other listening or viewing data. For example, the system described herein could also be used to collect data about habits related to one or more of the following categories:

AM

FM

TV

CD

SAT

AUDIO TAPE

VIDEO TAPE

MP3

DVD

PHONE

If one area of the foregoing categories is particularly important, more specific data such as the title of a CD or DVD, the title of an audio or video tape, to include the track or track numbers being listened to, could also be stored, transmitted to a data collection center, and analyzed.

As previously indicated, the stored or logged listener or viewer response data can be downloaded over a wireless connection or other bus connection from a telematics control unit in the vehicle to an integrated or remote data collection facility. Just when and how this happens is dependent on how the disclosed system is configured. Listener or viewer response data could be sent at regularly scheduled times, when a certain amount of listener or viewer response data has been stored, or on request by the listener or viewer or by the integrated or remote data collection facility. Other devices could also be used to trigger the listener or viewer response data download. However the listener or viewer response data download is initiated, a wireless connection is established to the integrated or remote data collection facility over whatever wireless or other communications path is chosen. The listener or viewer response data is then transmitted from the vehicle to the integrated or remote data collection facility. Once the-listener or viewer response data has been received correctly by the remote data collection facility 20, it is stored in a database 22 accessible by the data reduction application 24.

The purpose of the data reduction application 24 is to transform and manipulate the mass of downloaded listener or viewer response data into a form that is meaningful and usable by people who are reviewing broadcast station programming and commercial message effectiveness and coverage. The data reduction application 24 can be configured to provide many different reports based on the stored data. Some examples of reports include:

Broadcast stations tuned in, sorted by stated listener or viewer profile

Broadcast programs tuned into during the day and week, also sorted by stated listener or viewer profile

Commercials listened to, sorted by broadcast station, also sorted by stated listener or viewer profile

Within any predetermined group, how many muted the commercial?

How many listened to a particular commercial, no matter what station, muted?

Under what circumstances is the volume raised/lowered?

The size of the coverage area served by a particular station.

What stations are programmed into the buttons on the radio most frequently, also sorted by stated listener or viewer profile.

Cause for the listener or viewer to switch stations based on to what was played before the listener or viewer switched stations.

The reports produced by the data reduction application could be in the form of statistics, charts, graphs, trends, or in any other form easily usable by marketing or programming personnel. Changes in the program or commercial scheduling could then be tracked by watching the listener or viewer response to these changes. Commercial messages could be revised, abandoned, or re-targeted to a specific audience based on empirical results. Broadcast stations could better support the claims made to advertisers about their audience and coverage area. Advertisers could use tailored reports to produce trial commercial messages which could then be tailored to create effective commercial messages to draw listener interest. Stations could charge for commercial messages based on measured audience numbers. The entire process of commercial advertising would become quantitative rather than subjective.

The present invention, having now been disclosed according to its preferred and alternate embodiments, will now be understood by those of ordinary skill in the art. Those of ordinary skill in the art will understand that numerous other embodiments of the present invention may also be embodied by the foregoing disclosure. Such other embodiments shall be included within the scope and meaning of the appended claims.

What is claimed is:

1. A method for logging and reporting listener response data, comprising the steps of:
storing information about the identification of broadcast radio stations being played by a radio;
transmitting said information about the identification of broadcast radio stations to a data collection facility; and
providing a report of what radio stations a listener is listening to.

2. The method as defined in claim 1 further including the step of transmitting time information to said data collection facility to identify when said radio was playing a radio station.

3. The method as defined in claim 2 further including the step of transmitting location information to said data collection facility to identify where said radio was playing each radio station.

4. The method as defined in claim 3 further including the step of transmitting radio values setting information to said data collection facility to identify how loud the radio was playing each radio station.

5. The method as defined in claim 4 where said radio volume setting information is used to determine if said radio was being listened to at a particular time.

6. The method as defined in claim 1 further including the step of using the location of the radio to identify the coverage area of a radio station.

7. The method as defined in claim 1 further including the step of determining if a specific event is associated with radio listening, said specific event being selected from a group including AM, FM, TV, CD, SAT, AUDIO TAPE, VIDEO TAPE, MP3, DVD, and PHONE.

8. The method as defined in claim 1 further including the step of determining the identification of a compact disc and track number listened to during a predetermined time.

9. A method for logging and reporting listener response data, comprising the step of:
storing information about the identification of CD or other non-broadcast music being played by the vehicle sound system.

10. The method as defined in claim 9 further including the steps of:
transmitting said stored information to a data collection facility; and
providing a report of what music a listener is listening to.

11. A method for logging and reporting listener response data, comprising the step of:
storing information about the identification of DVD or other sources of video and audio being watched and listened to by the vehicle occupants.

12. The method as defined in claim 11 further including the steps of:
transmitting said stored information to a data collection facility; and
providing a report on what video the vehicle occupants are watching.
